(19) United States
(12) Patent Application Publication
(10) Pub. No.: US 2026/0288478 A1
(43) Pub. Date: Sep. 24, 2026

(54) INFORMATION MANAGEMENT SYSTEM, HARDWARE MONITORING APPARATUS, INFORMATION MANAGEMENT APPARATUS, INFORMATION MANAGEMENT METHOD, AND COMPUTER-READABLE RECORDING MEDIUM

(71) Applicant: NEC Corporation, Tokyo (JP)

(72) Inventor: Keisuke INA, Tokyo (JP)

(73) Assignee: NEC Corporation, Tokyo (JP)

(21) Appl. No.: 19/558,825

(22) Filed: Mar. 6, 2026

(30) Foreign Application Priority Data
Mar. 19, 2025 (JP) 2025-044203

(51) Int. Cl. G06F 9/4401

(52) U.S. Cl. CPC G06F 9/4405

(57) ABSTRACT

An information management system includes an information management apparatus and a hardware monitoring apparatus. The hardware monitoring apparatus includes a hardware change detection unit that detects a change of hardware of a calculator using an electronic certificate issued by the information management apparatus, an information generation unit that generates hardware configuration information for specifying content of the change of the hardware, and an information transmission unit that transmits the hardware configuration information to the information management apparatus. The information management apparatus includes an information acquisition unit that acquires hardware change information for specifying the changed hardware, a determination processing unit that determines whether the hardware change information and the hardware configuration information are consistent, and a management unit that updates the electronic certificate when the hardware change information and the hardware configuration information are consistent.

### INCORPORATION BY REFERENCE

This application is based upon and claims the benefit of priority from Japanese patent application No. 2025-044203, filed on March 19, 2025, the disclosure of which is incorporated herein in its entirety by reference.

### TECHNICAL FIELD

The present disclosure relates to a technique for managing information of hardware configuring a computer system.

### BACKGROUND ART

In recent years, in the field of computer systems, there has been a request for disclosing a source of hardware constituting a computer through a supply chain from viewpoints of economic stability and security. This is particularly noticeable in defense, core infrastructure, finance, and communication.

In order to respond to such a request, it is necessary to ensure traceability of a hardware change in an operating computer system. Therefore, conventionally, a system for managing hardware of a computer system has been proposed.

For example, JP 2007-034437 A discloses a system that manages vendor information and information necessary for maintenance work for each piece of hardware constituting a computer system. Furthermore, the system disclosed in JP 2007-034437 A also has a function of searching for a vendor and acquiring information necessary for maintenance regarding hardware for which a maintenance contract and a license contract are not concluded.

According to the system disclosed in JP 2007-034437 A, since hardware information is managed even when the hardware is changed in the computer system, it is considered that a source of hardware is disclosed.

### SUMMARY

However, even if the system disclosed in JP 2007-034437 A is used, after performing work such as hardware replacement for maintenance, an administrator needs to manually input information based on the content of the work and update the information on the system. Therefore, there is a possibility of being updated with incorrect information and a possibility that the input is missing, and the system disclosed in JP 2007-034437 A has a problem that the reliability of traceability is low.

An object of the present disclosure is to improve the reliability of traceability in a hardware change in a computer system.

In order to achieve the above object, an information management system according to one aspect of the present disclosure includes an information management apparatus that issues an electronic certificate that certifies a hardware configuration of a calculator and a hardware monitoring apparatus mounted on the calculator, wherein the hardware monitoring apparatus includes a hardware change detection unit that detects a change of hardware of the calculator using the electronic certificate, an information generation unit that generates hardware configuration information for specifying content of the detected change of the hardware, and an information transmission unit that transmits the hardware configuration information to the information management apparatus, and the information management apparatus includes an information acquisition unit that acquires hardware change information for specifying the hardware changed in the calculator, a determination processing unit that compares the acquired hardware change information with the transmitted hardware configuration information and determines whether the hardware change information and the hardware configuration information are consistent, and a management unit that updates the electronic certificate when the hardware change information and the hardware configuration information are consistent.

In order to achieve the above object, a hardware monitoring apparatus according to one aspect of the present disclosure is an apparatus mounted on a calculator, and includes a hardware change detection unit configured to detect a change of hardware of the calculator using an electronic certificate that is issued by an information management apparatus and certifies a hardware configuration of the calculator, an information generation unit configured to generate hardware configuration information for specifying content of the detected change of the hardware, and an information transmission unit configured to transmit the hardware configuration information to the information management apparatus.

In order to achieve the above object, an information management apparatus according to one aspect of the present disclosure includes an electronic certificate issuing unit that issues an electronic certificate that certifies a hardware configuration of a calculator, an information acquisition unit that acquires hardware change information for specifying hardware changed in the calculator, a determination processing unit that compares the acquired hardware change information with transmitted hardware configuration information and determines whether the hardware change information and the hardware configuration information are consistent when a hardware change of the calculator is detected using the electronic certificate and the hardware configuration information for specifying content of the detected hardware change is further transmitted in a hardware monitoring apparatus mounted on the calculator, and a management unit that updates the electronic certificate when the hardware change information and the hardware configuration information are consistent.

In order to achieve the above object, an information management method according to one aspect of the present disclosure is a method, executed by an information management apparatus that issues an electronic certificate that certifies a hardware configuration of a calculator and a hardware monitoring apparatus mounted on the calculator, and includes a hardware change detection step of detecting, by the hardware monitoring apparatus, a change of hardware of the calculator using the electronic certificate, an information generation step of generating, by the hardware monitoring apparatus, hardware configuration information for specifying content of the detected change of the hardware, an information transmission step of transmitting, by the hardware monitoring apparatus, the hardware configuration information to the information management apparatus, an information acquisition step of acquiring, by the information management apparatus, hardware change information for specifying the hardware changed in the calculator, a determination processing step of comparing, by the information management apparatus, the acquired hardware change information with the transmitted hardware configuration information, and determining whether the hardware change information and the hardware configuration information are consistent, and a management step of updating, by the information management apparatus, the electronic certificate when the hardware change information and the hardware configuration information are consistent.

Furthermore, in order to achieve the above object, a first computer-readable recording medium according to one aspect of the present disclosure including a program recorded thereon, the program being installed in a calculator and including instructions for causing the calculator to execute a hardware change detection step of detecting a hardware change of the calculator using an electronic certificate that is issued by an information management apparatus and certifies a hardware configuration of the calculator, a step of generating hardware configuration information for specifying content of the detected hardware change, and an information transmission step of transmitting the hardware configuration information to the information management apparatus.

Furthermore, in order to achieve the above object, a second computer-readable recording medium according to one aspect of the present disclosure includes a program recorded thereon, the program including instructions for causing a computer to execute an electronic certificate issuing step of issuing an electronic certificate that certifies a hardware configuration of a calculator different from the computer, an information acquisition step of acquiring hardware change information for specifying hardware changed in the calculator, a determination processing step of comparing the acquired hardware change information with transmitted hardware configuration information and determining whether the hardware change information and the hardware configuration information are consistent when a hardware change of the calculator is detected using the electronic certificate and the hardware configuration information for specifying content of the detected hardware change is further transmitted in a hardware monitoring apparatus mounted on the calculator, and a management step of updating the electronic certificate when the hardware change information and the hardware configuration information are consistent.

As described above, according to the present disclosure, it is possible to improve the reliability of traceability in the hardware change in the computer system.

### BRIEF DESCRIPTION OF THE DRAWINGS

FIG. 1 is a configuration diagram illustrating an exemplary schematic configuration of each of a hardware monitoring apparatus, an information management apparatus, and an information management system;

FIG. 2 is a configuration diagram specifically illustrating an exemplary configuration of each of the hardware monitoring apparatus, the information management apparatus, and the information management system;

FIG. 3 is a sequence diagram illustrating a flow of processing of each of the hardware monitoring apparatus, the information management apparatus, and the information management system;

FIG. 4 is a diagram illustrating an example of an operation of the hardware monitoring apparatus;

FIG. 5 is a diagram illustrating an example of an operation of the information management apparatus; and

FIG. 6 is a block diagram illustrating an example of a computer that implements the hardware monitoring apparatus or the information management apparatus.

### EXAMPLE EMBODIMENT

### Example Embodiment

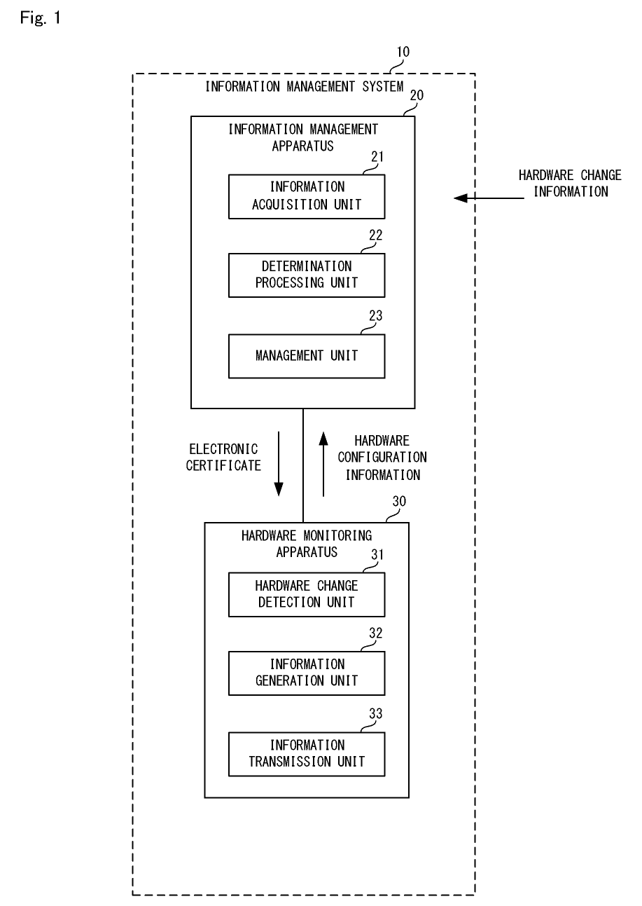

Hereinafter, a hardware monitoring apparatus, an information management apparatus, an information management system, an information management method, a first program, and a second program in an example embodiment will be described with reference to FIGS. 1 to 6.

### Apparatus Configuration

First, schematic configurations of the hardware monitoring apparatus, the information management apparatus, and the information management system will be described with reference to FIG. 1. FIG. 1 is a configuration diagram illustrating an exemplary schematic configuration of each of the hardware monitoring apparatus, the information management apparatus, and the information management system.

An information management system 10 illustrated in FIG. 1 is a system for managing information of hardware constituting a calculator. As illustrated in FIG. 1, the information management system 10 includes an information management apparatus 20 and a hardware monitoring apparatus 30.

The hardware monitoring apparatus 30 illustrated in FIG. 1 is mounted on the calculator. As illustrated in FIG. 1, the hardware monitoring apparatus 30 includes a hardware change detection unit 31, an information generation unit 32, and an information transmission unit 33.

The hardware change detection unit 31 detects a change of hardware of the calculator using an electronic certificate. The electronic certificate is a certificate that certifies a hardware configuration of a calculator 100 and is issued by the information management apparatus 20.

The information generation unit 32 generates hardware configuration information for specifying the content of the detected hardware change. The information transmission unit 33 transmits the hardware configuration information to the information management apparatus 20.

As described above, the information management apparatus 20 illustrated in FIG. 1 issues the electronic certificate that certifies the hardware configuration of the calculator. As illustrated in FIG. 1, the information management apparatus 20 includes an information acquisition unit 21, a determination processing unit 22, and a management unit 23.

The information acquisition unit 21 acquires hardware change information for specifying hardware changed in the calculator 100. Examples of an acquisition destination of the hardware change information include a terminal apparatus of a person in charge who has performed work of changing the hardware of the calculator.

The determination processing unit 22 compares the acquired hardware change information with the hardware configuration information transmitted from the hardware monitoring apparatus 30, and determines whether the hardware change information and the hardware configuration information are consistent. In a case where the hardware change information and the hardware configuration information are consistent, the management unit 23 updates the electronic certificate.

As described above, in the information management system 10, the hardware configuration information generated by the hardware monitoring apparatus 30 and the hardware change information are compared, and the electronic certificate is updated on condition that the hardware change information and the hardware configuration information are consistent. Therefore, a possibility that the electronic certificate is updated with incorrect information can be reduced in the information management system 10. Further, in a case where the hardware change information and the hardware configuration information are not consistent, there is a possibility that an input regarding the change of the hardware configuration is missing, and it is possible to identify the missing of the input. According to the information management system 10, it is possible to improve the reliability of traceability in the hardware change in a computer system (the calculator).

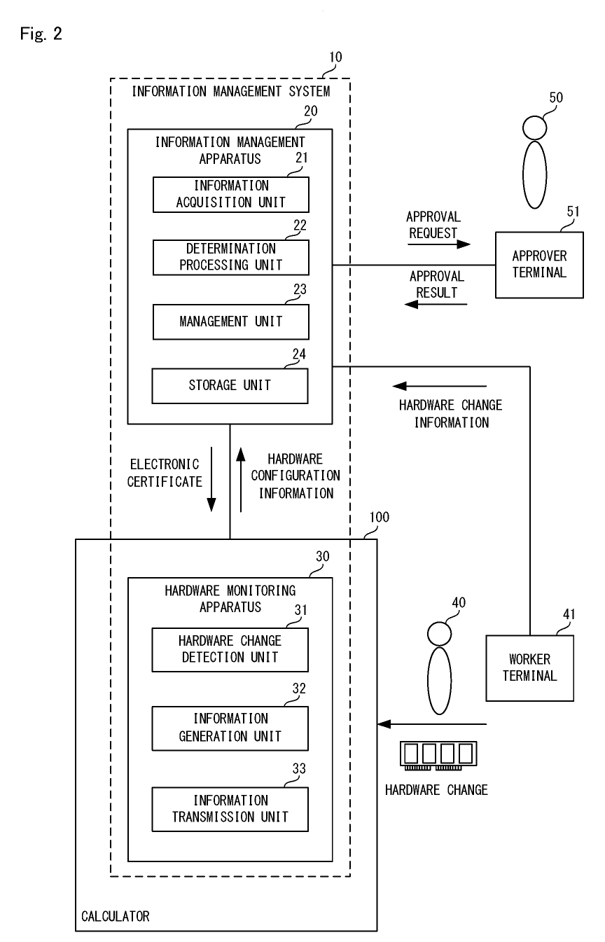

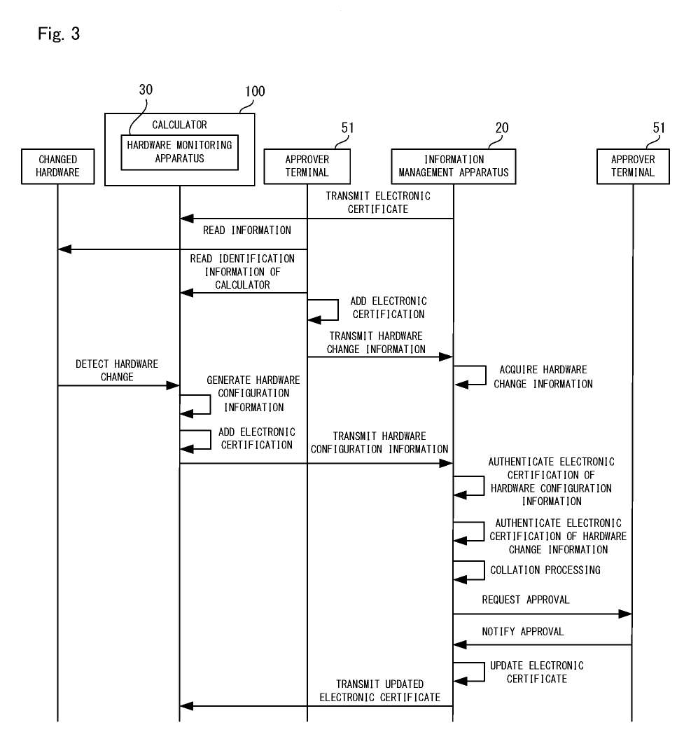

Next, a configuration and a function of each of the hardware monitoring apparatus, the information management apparatus, and the information management system will be specifically described with reference to FIGS. 2 and 3. FIG. 2 is a configuration diagram specifically illustrating an exemplary configuration of each of the hardware monitoring apparatus, the information management apparatus, and the information management system. FIG. 3 is a sequence diagram illustrating a flow of processing of each of the hardware monitoring apparatus, the information management apparatus, and the information management system. In the following description, FIG. 3 will be referred to as appropriate.

As illustrated in FIG. 2, the hardware monitoring apparatus 30 is mounted on the calculator 100. Specifically, the hardware monitoring apparatus 30 is constructed by a program that operates on an operating system (OS) of the calculator 100.

As illustrated in FIG. 2, the information management apparatus 20 is connected to a terminal apparatus (hereinafter, referred to as a “worker terminal”) 41 used by a worker 40 and a terminal apparatus (hereinafter, referred to as an “approver terminal”) 51 of an approver 50 who approves a hardware change in the calculator 100 so as to enable data communication.

The worker 40 changes hardware such as a memory in the calculator 100. At this time, the worker 40 inputs information on the changed hardware and identification information of the calculator 100 to his/her worker terminal 41. The information may be input directly by the worker 40 using a keyboard, a touch panel, or the like, or may be input by reading a two-dimensional code assigned to the hardware and the calculator 100 with a camera of the worker terminal 41.

The worker terminal 41 generates hardware change information for specifying the hardware changed in the calculator 100 using the input hardware information and the input identification information of the calculator 100. Furthermore, the worker terminal 41 can register an electronic certification of the worker in advance. In this case, the worker terminal 41 adds the electronic certification of the worker to the hardware change information, and transmits, to the information management apparatus 20, the hardware change information to which the electronic certification is added.

The worker terminal 41 can also execute authentication with a password, biometric information, or the like for the worker. Then, the worker terminal 41 adds the electronic certification to the hardware change information on condition that the authentication is successful.

In the hardware monitoring apparatus 30, for example, the hardware change detection unit 31 detects a change of hardware using an electronic certificate issued by the information management apparatus 20 every fixed period. The electronic certificate certifies, for example, an initial hardware configuration of the calculator 100 and a portion changed from the initial hardware configuration.

Specifically, the hardware change detection unit 31 first specifies the latest hardware configuration of the calculator 100 using the electronic certificate. Next, the hardware change detection unit 31 extracts a hardware configuration from the OS of the calculator 100.

Then, the hardware change detection unit 31 collates the hardware configuration specified by the electronic certificate with the hardware configuration extracted from the OS. If there is a difference between the hardware change information and the hardware configuration information as a result of the collation, the hardware change detection unit 31 specifies a portion corresponding to the difference in the hardware configuration extracted from the OS as a portion in which hardware is changed.

The information generation unit 32 generates the hardware configuration information using the changed portion detected by the hardware change detection unit 31. Specifically, the information generation unit 32 generates the hardware configuration information by adding the specified changed portion to the hardware configuration specified by the electronic certificate.

Furthermore, the calculator 100 can register an electronic certificate that certifies itself in advance. In this case, the information generation unit 32 adds an electronic signature of the calculator 100 to the hardware configuration information. Furthermore, the information transmission unit 33 transmits, to the information management apparatus 20, the hardware configuration information to which the electronic signature is added.

As illustrated in FIG. 2, the information management apparatus 20 includes a storage unit 24 in addition to the information acquisition unit 21, the determination processing unit 22, and the management unit 23 described above. The storage unit 24 stores the electronic certificate that certifies the hardware configuration of the calculator.

In the example embodiment, the information acquisition unit 21 acquires the hardware change information from the worker terminal 41. In a case where the electronic certification of the worker is added to the hardware change information, the information acquisition unit 21 acquires the hardware change information to which the electronic certification is added.

In a case where an electronic certification is added to each of the hardware change information and the hardware configuration information, the determination processing unit 22 first authenticates each of the electronic certifications. When the authentication is successful in each of the electronic certifications, the determination processing unit 22 compares (collates) the hardware change information with the hardware configuration information.

When the hardware change information and the hardware configuration information are consistent, the determination processing unit 22 transmits, to the approver terminal 51, information indicating the changed portion of the hardware configuration, information for specifying the worker 40, and information for specifying the calculator 100. Then, the determination processing unit 22 requests approval for the hardware change from the approver 50 via the approver terminal 51.

When the approver terminal 51 transmits a notification of approval to the information management apparatus 20, the management unit 23 manages information indicating a change of the hardware configuration as trail information. Specifically, the trail information includes, for example, the date and time when work of changing hardware was performed, a worker ID, an approver ID, a calculator ID, information on the changed hardware, content of the work, and the like. Furthermore, the management unit 23 updates the electronic certificate based on the hardware configuration information or the hardware change information.

### Apparatus Operation

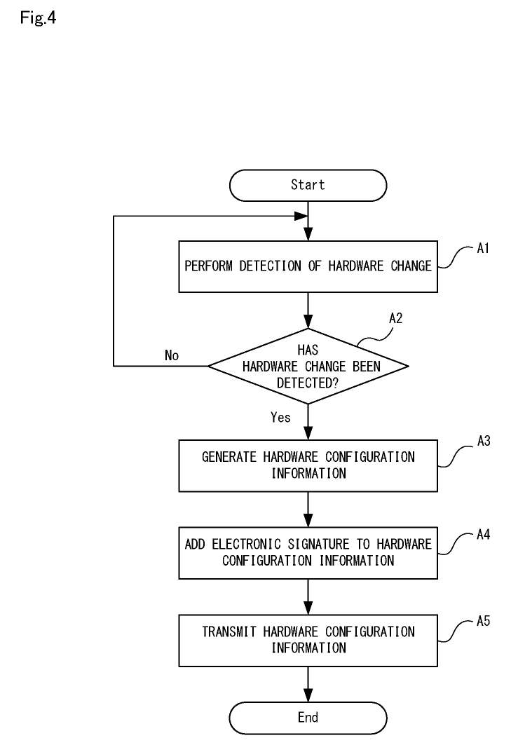

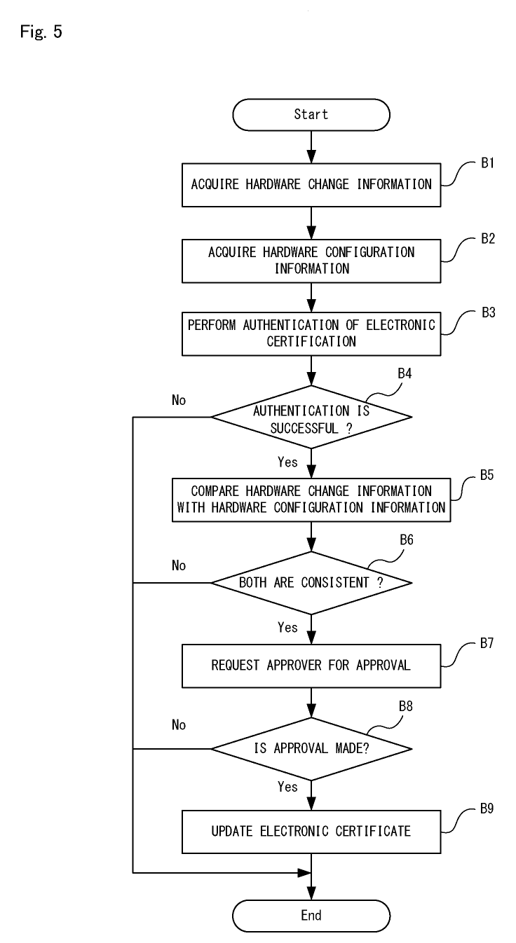

Next, an exemplary operation of each of the hardware monitoring apparatus, the information management apparatus, and the information management system will be described with reference to FIGS. 4 and 5. FIGS. 1 to 3 will be appropriately referred to in the following description. In the example embodiment, the hardware monitoring apparatus 30 and the information management apparatus 20 are operated to implement the information management method. Therefore, the description of the information management method is replaced with the following description of the operations of the hardware monitoring apparatus 30 and the information management apparatus 20.

As a premise, the information management apparatus 20 issues an electronic certificate in advance and transmits the issued electronic certificate to the hardware monitoring apparatus 30. Furthermore, the worker 40 changes hardware such as a memory in the calculator 100. Thereafter, the worker terminal 41 generates hardware change information and adds an electronic certification of the worker and transmits, to the information management apparatus 20, the hardware change information to which the electronic certification is added.

First, the operation of the hardware monitoring apparatus 30 will be described. FIG. 4 is a diagram illustrating an example of the operation of the hardware monitoring apparatus.

As illustrated in FIG. 4, first, the hardware change detection unit 31 detects a change of hardware using an electronic certificate issued by the information management apparatus 20 (step A1), and determines whether the change of the hardware has been detected (step A2).

Specifically, in step A1, the hardware change detection unit 31 collates a hardware configuration specified by the electronic certificate with a hardware configuration extracted from the OS of the calculator 100. In step A2, the hardware change detection unit 31 determines whether there is a difference between the hardware change information and the hardware configuration information as a result of the collation.

In a case where the change of the hardware has not been detected as a result of the determination in step A2, the information generation unit 32 enters a standby state and executes step A1 again after a lapse of a certain period of time.

On the other hand, in a case where the change of the hardware has been detected as a result of the determination in step A2, the information generation unit 32 generates hardware configuration information using a changed portion detected in step A1 (step A3).

Specifically, in step A3, the information generation unit 32 generates the hardware configuration information by adding the specified changed portion to the hardware configuration specified by the electronic certificate.

Next, the information generation unit 32 adds an electronic signature of the calculator 100 to the hardware configuration information (step A4).

Thereafter, the information transmission unit 33 transmits, to the information management apparatus 20, the hardware configuration information to which the electronic signature is added (step A5). After step A5 is executed, step A1 is executed again after a lapse of a certain period of time.

Next, the operation of the information management apparatus 20 will be described. FIG. 5 is a diagram illustrating an example of the operation of the information management apparatus.

As illustrated in FIG. 5, first, the information acquisition unit 21 acquires hardware change information from the worker terminal 41 (step B1). In step B1, an electronic certification of the worker is added to the hardware change information.

Next, the information acquisition unit 21 acquires the hardware configuration information transmitted from the hardware monitoring apparatus 30 (step B2).

Next, the determination processing unit 22 authenticates the electronic certification added to the hardware change information and an electronic certification added to the hardware configuration information (step B3). Further, the determination processing unit 22 determines whether authentication is successful for each of the electronic certifications (step B4).

In a case where the authentication is not successful in any of the electronic certifications as a result of the determination in step B4, the processing in the information management apparatus 20 ends.

On the other hand, in a case where the authentication is successful in each of the electronic certifications as a result of the determination in step B4, the determination processing unit 22 compares (collates) the hardware change information with the hardware configuration information (step 5), and determines whether the hardware change information and the hardware configuration information are consistent (step B6).

In a case where the hardware change information and the hardware configuration information are not consistent as a result of the determination in step B6, the processing in the information management apparatus 20 ends.

On the other hand, in a case where the hardware change information and the hardware configuration information are consistent as a result of the determination in step B6, the determination processing unit 22 requests the approver 50 to approve the hardware change via the approver terminal 51 (step B7).

Specifically, in step B7, the determination processing unit 22 transmits, to the approver terminal 51, information indicating the portion of which the hardware configuration has been changed, information for specifying the worker 40, and information for specifying the calculator 100.

Next, the determination processing unit 22 confirms a notification from the approver terminal 51, and determines whether approval is made (step B8).

In a case where the approval is made as a result of the determination in step B8, the management unit 23 updates the electronic certificate based on the hardware configuration information or the hardware change information (step B9). Furthermore, in step B9, the management unit 23 manages, for example, the date and time when the work of changing the hardware was performed, the worker ID, the approver ID, the calculator ID, the information on the changed hardware, the content of the work, and the like as the trail information.

In a case where the approval is made as a result of the determination in step B8, the processing in the information management apparatus 20 ends.

### Effects of Example Embodiment

As described above, in the information management system 10, the hardware configuration information is generated based on the electronic certificate by the hardware monitoring apparatus 30, and the hardware change information is generated based on the input by the worker 40. After the hardware change information and the hardware configuration information are collated, the electronic certificate is updated in the information management system 10. Therefore, according to the example embodiment, the possibility that the electronic certificate is updated with incorrect information and the possibility that the worker forgets to perform the input are greatly reduced. As a result, the reliability of traceability in the calculator 100 is improved.

### Modifications

Hereinafter, modifications of the example embodiment will be described.

### First Modification

In a first modification, before requesting the approver 50 to approve a change of hardware, the information management apparatus 20 can request a hardware shipment source to confirm validity of the hardware.

Specifically, the determination processing unit 22 transmits hardware identification information, for example, a model number, a serial number, and the like to a terminal apparatus of the hardware shipment source to request for the confirmation of the validity. In this case, the terminal apparatus of the hardware shipment source determines whether the hardware has been properly shipped from the received identification information, and transmits the determination result to the information management apparatus 20.

According to the first modification, a source of a changed hardware can be clarified, and traceability can be improved. Further, according to the first modification, it is possible to reduce a possibility of a failure due to the hardware change.

### Second Modification

In a second modification, the information management apparatus 20 can issue an electronic certificate including a first electronic certificate and a second electronic certificate. The first electronic certificate certifies an initial hardware configuration (hardware configuration at the time of factory shipment) of the calculator 100. The second electronic certificate certifies a portion that has been changed from the initial hardware configuration. In the second modification, the management unit 23 updates the electronic certificate by newly issuing the second electronic certificate indicating the changed hardware.

According to the second modification, since the newly changed hardware is certified by the second electronic certificate, it is easy to manage a difference caused by the hardware change in the calculator 100. Furthermore, the second electronic certificate may be issued every time the hardware configuration is changed. In this case, it is easier to manage the difference.

### Program

In the example embodiment, it is sufficient that a first program is a program that causes a computer to execute steps A1 to A5 illustrated in FIG. 4. By installing the program in the computer and executing the program, the hardware monitoring apparatus 30 can be achieved. In this case, a processor of the computer functions as the hardware change detection unit 31, the information generation unit 32, and the information transmission unit 33, and performs processing. Examples of the computer include the calculator 100 as described above, and specifically include a server apparatus and a general-purpose PC, and also include a smartphone and a tablet terminal apparatus.

In the example embodiment, it is sufficient that a second program is a program that causes a computer to execute steps B1 to B9 illustrated in FIG. 5. By installing the program in the computer and executing the program, the information management apparatus 20 can be achieved. In this case, the processor of the computer functions as the information acquisition unit 21, the determination processing unit 22, and the management unit 23, and performs processing. Furthermore, the storage unit 24 is achieved by a storage device provided in the computer. Examples of the computer include a smartphone and a tablet terminal apparatus in addition to a server apparatus and a general-purpose PC.

Furthermore, the second program may be executed by a computer system constructed by a plurality of computers. In this case, for example, each computer may function as any of the information acquisition unit 21, the determination processing unit 22, and the management unit 23.

### Physical Configuration

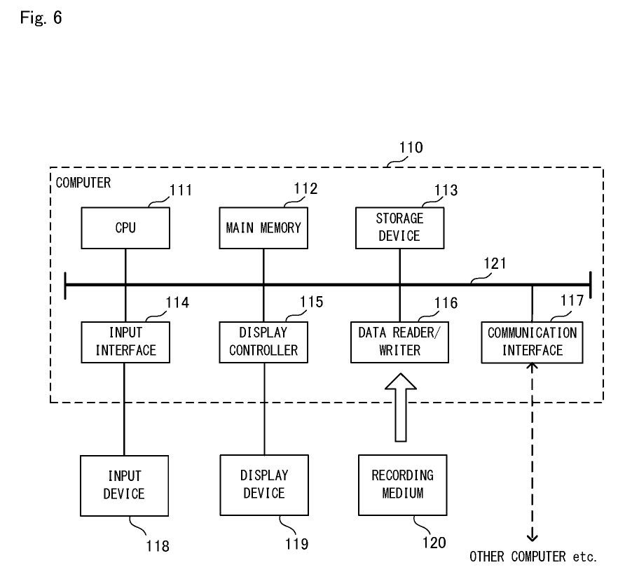

Here, an example of the calculator 100 that achieves the hardware monitoring apparatus 30 by executing the first program and an example of a computer that achieves the information management apparatus 20 by executing the second program will be described with reference to FIG. 6. FIG. 6 is a block diagram illustrating an example of a computer that achieves the hardware monitoring apparatus or the information management apparatus.

As illustrated in FIG. 6, a computer 110 includes a central processing unit (CPU) 111, a main memory 112, a storage device 113, an input interface 114, a display controller 115, a data reader/writer 116, and a communication interface 117. These units are connected via a bus 121 in such a way as to be able to execute data communication with each other.

The computer 110 may include a graphics processing unit (GPU), an application specific integrated circuit (ASIC), or a field-programmable gate array (FPGA), in addition to the CPU 111 or instead of the CPU 111. In this aspect, the GPU, the ASIC, or the FPGA can execute the program in the example embodiment.

The CPU 111 loads the program in the example embodiment stored in the storage device 113 and configured by codes to the main memory 112, and executes the codes in a predetermined order to execute various computations. The main memory 112 is typically a volatile storage device such as a dynamic random access memory (DRAM).

The program in the example embodiment is provided in a state of being stored in a computer-readable recording medium 120. The program in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and an input device 118 such as a keyboard and a mouse. The display controller 115 is connected to a display device 119, and controls display on the display device 119.

The data reader/writer 116 mediates data transmission between the CPU 111 and the recording medium 120, reads a program from the recording medium 120, and writes a processing result of the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) and Secure Digital (SD), a magnetic recording medium such as a flexible disk, and an optical recording medium such as a compact disk read only memory (CD-ROM).

Each of the hardware monitoring apparatus 30 and the information management apparatus 20 can also be achieved using hardware corresponding to each unit, for example, an electronic circuit, instead of the computer in which the program is installed. Further, a part of each of the hardware monitoring apparatus 30 and the information management apparatus 20 may be achieved by a program, and the remaining part may be achieved by hardware. In the example embodiment, the computer is not limited to the computer illustrated in FIG. 6.

Some or all of the above-described example embodiments can be expressed by (Supplementary Note 1) to (Supplementary Note 12) described below, but are not limited to the following description.

### Supplementary Note 1

An information management system including:

an information management apparatus configured to issue an electronic certificate that certifies a hardware configuration of a calculator; and

a hardware monitoring apparatus mounted on the calculator,

wherein the hardware monitoring apparatus includes:

a hardware change detection unit configured to detect a change of hardware of the calculator using the electronic certificate;

an information generation unit configured to generate hardware configuration information for specifying content of the detected change of the hardware; and

an information transmission unit configured to transmit the hardware configuration information to the information management apparatus, and

the information management apparatus includes:

an information acquisition unit configured to acquire hardware change information for specifying the hardware changed in the calculator;

a determination processing unit configured to compare the acquired hardware change information with the transmitted hardware configuration information and determine whether the hardware change information and the hardware configuration information are consistent; and

a management unit configured to update the electronic certificate when the hardware change information and the hardware configuration information are consistent.

### Supplementary Note 2

The information management system according to Supplementary Note 1, wherein

in the information management apparatus,

the determination processing unit requests approval for the change of the hardware from a preset terminal apparatus when the hardware change information and the hardware configuration information are consistent, and

the management unit updates the electronic certificate when there is a notification of approval from the terminal apparatus.

### Supplementary Note 3

The information management system according to Supplementary Note 1, wherein

the electronic certificate includes a first electronic certificate that certifies an initial hardware configuration of the calculator and a second electronic certificate that certifies a portion changed from the initial hardware configuration, and

in the information management apparatus,

the management unit issues the second electronic certificate to update the electronic certificate.

### Supplementary Note 4

The information management system according to Supplementary Note 1, wherein

in the hardware monitoring apparatus,

the information generation unit adds an electronic signature of the calculator to the hardware configuration information,

the information transmission unit transmits the hardware configuration information to which the electronic signature is added, and

in the information management apparatus,

the information acquisition unit acquires the hardware change information to which an electronic signature of a person in charge who has performed work of changing the hardware of the calculator is added, and

the determination processing unit performs an authentication process for each of the electronic signature of the calculator added to the hardware configuration information and the electronic signature of the person in charge added to the hardware change information, and when each authentication is successful, compares the acquired hardware change information with the transmitted hardware configuration information to determine whether the hardware change information and the hardware configuration information are consistent.

### Supplementary Note 5

A hardware monitoring apparatus mounted on a calculator, the hardware monitoring apparatus including:

a hardware change detection unit configured to detect a change of hardware of the calculator using an electronic certificate that is issued by an information management apparatus and certifies a hardware configuration of the calculator;

an information generation unit configured to generate hardware configuration information for specifying content of the detected change of the hardware; and

an information transmission unit configured to transmit the hardware configuration information to the information management apparatus.

### Supplementary Note 6

An information management apparatus including:

an electronic certificate issuing unit configured to issue an electronic certificate that certifies a hardware configuration of a calculator;

an information acquisition unit configured to acquire hardware change information for specifying hardware changed in the calculator;

a determination processing unit configured to compare the acquired hardware change information with transmitted hardware configuration information and determine whether the hardware change information and the hardware configuration information are consistent when a hardware change of the calculator is detected using the electronic certificate and the hardware configuration information for specifying content of the detected hardware change is further transmitted in a hardware monitoring apparatus mounted on the calculator; and

a management unit configured to update the electronic certificate when the hardware change information and the hardware configuration information are consistent.

### Supplementary Note 7

An information management method, executed by an information management apparatus configured to issue an electronic certificate that certifies a hardware configuration of a calculator and a hardware monitoring apparatus mounted on the calculator, the information management method including:

a hardware change detection step of detecting, by the hardware monitoring apparatus, a change of hardware of the calculator using the electronic certificate;

an information generation step of generating, by the hardware monitoring apparatus, hardware configuration information for specifying content of the detected change of the hardware;

an information transmission step of transmitting, by the hardware monitoring apparatus, the hardware configuration information to the information management apparatus;

an information acquisition step of acquiring, by the information management apparatus, hardware change information for specifying the hardware changed in the calculator;

a determination processing step of comparing, by the information management apparatus, the acquired hardware change information with the transmitted hardware configuration information, and determining whether the hardware change information and the hardware configuration information are consistent; and

a management step of updating, by the information management apparatus, the electronic certificate when the hardware change information and the hardware configuration information are consistent.

### Supplementary Note 8

The information management method according to Supplementary Note 7, wherein

the information management apparatus requests a preset terminal apparatus to approve the change of the hardware in a case where the hardware change information and the hardware configuration information are consistent in the determination, and

the information management apparatus updates the electronic certificate when there is a notification of approval from the terminal apparatus.

### Supplementary Note 9

The information management method according to Supplementary Note 7, wherein

the electronic certificate includes a first electronic certificate that certifies an initial hardware configuration of the calculator and a second electronic certificate that certifies a portion changed from the initial hardware configuration, and

the information management apparatus issues the second electronic certificate to update the electronic certificate in the management step.

### Supplementary Note 10

The information management method according to Supplementary Note 7, wherein

the hardware monitoring apparatus adds an electronic signature of the calculator to the hardware configuration information in the information generation step,

the hardware monitoring apparatus transmits the hardware configuration information to which the electronic signature is added in the information transmission step,

the information management apparatus acquires the hardware change information to which an electronic signature of a person in charge who has performed work of changing the hardware of the calculator is added in the information acquisition step, and

the information management apparatus performs an authentication process for each of the electronic signature of the calculator added to the hardware configuration information and the electronic signature of the person in charge added to the hardware change information, and when the authentication of each of the electronic signatures is successful, comparing the acquired hardware change information with the transmitted hardware configuration information, and determining whether the hardware change information and the hardware configuration information are consistent in the determination processing step.

### Supplementary Note 11

A computer-readable recording medium on which a program is recorded, the program being installed in a calculator and including instructions for causing the calculator to execute:

a hardware change detection step of detecting a hardware change of the calculator using an electronic certificate that is issued by an information management apparatus and certifies a hardware configuration of the calculator;

a step of generating hardware configuration information for specifying content of the detected hardware change; and

an information transmission step of transmitting the hardware configuration information to the information management apparatus.

### Supplementary Note 12

A computer-readable recording medium on which a program is recorded, the program including instructions for causing a computer to execute:

an electronic certificate issuing step of issuing an electronic certificate that certifies a hardware configuration of a calculator different from the computer;

an information acquisition step of acquiring hardware change information for specifying hardware changed in the calculator;

a determination processing step of comparing the acquired hardware change information with transmitted hardware configuration information and determining whether the hardware change information and the hardware configuration information are consistent when a hardware change of the calculator is detected using the electronic certificate and the hardware configuration information for specifying content of the detected hardware change is further transmitted in a hardware monitoring apparatus mounted on the calculator; and

a management step of updating the electronic certificate when the hardware change information and the hardware configuration information are consistent.

As described above, according to the present disclosure, it is possible to improve the reliability of traceability in the hardware change in the computer system. The present disclosure is useful for various computer systems.

What is claimed is:

1. An information management system comprising:
an information management apparatus configured to issue an electronic certificate that certifies a hardware configuration of a calculator; and
a hardware monitoring apparatus mounted on the calculator,
wherein the hardware monitoring apparatus comprises:
a hardware change detection unit configured to detect a change of hardware of the calculator using the electronic certificate;
an information generation unit configured to generate hardware configuration information for specifying content of the detected change of the hardware; and
an information transmission unit configured to transmit the hardware configuration information to the information management apparatus, and
the information management apparatus comprises:
an information acquisition unit configured to acquire hardware change information for specifying the hardware changed in the calculator;
a determination processing unit configured to compare the acquired hardware change information with the transmitted hardware configuration information and determine whether the hardware change information and the hardware configuration information are consistent; and
a management unit configured to update the electronic certificate when the hardware change information and the hardware configuration information are consistent.

2. The information management system according to claim 1, wherein
in the information management apparatus,
the determination processing unit requests approval for the change of the hardware from a preset terminal apparatus when the hardware change information and the hardware configuration information are consistent, and
the management unit updates the electronic certificate when there is a notification of approval from the terminal apparatus.

3. The information management system according to claim 1, wherein
the electronic certificate includes a first electronic certificate that certifies an initial hardware configuration of the calculator and a second electronic certificate that certifies a portion changed from the initial hardware configuration, and
in the information management apparatus,
the management unit issues the second electronic certificate to update the electronic certificate.

4. The information management system according to claim 1, wherein
in the hardware monitoring apparatus,
the information generation unit adds an electronic signature of the calculator to the hardware configuration information,
the information transmission unit transmits the hardware configuration information to which the electronic signature is added, and
in the information management apparatus,
the information acquisition unit acquires the hardware change information to which an electronic signature of a person in charge who has performed work of changing the hardware of the calculator is added, and
the determination processing unit performs an authentication process for each of the electronic signature of the calculator added to the hardware configuration information and the electronic signature of the person in charge added to the hardware change information, and when authentication of each of the electronic signatures is successful, compares the acquired hardware change information with the transmitted hardware configuration information to determine whether the hardware change information and the hardware configuration information are consistent.

5. An information management method, executed by an information management apparatus configured to issue an electronic certificate that certifies a hardware configuration of a calculator and a hardware monitoring apparatus mounted on the calculator, the information management method comprising:
detecting, by the hardware monitoring apparatus, a change of hardware of the calculator using the electronic certificate;
generating, by the hardware monitoring apparatus, hardware configuration information for specifying content of the detected change of the hardware;
transmitting, by the hardware monitoring apparatus, the hardware configuration information to the information management apparatus;
acquiring, by the information management apparatus, hardware change information for specifying the hardware changed in the calculator;
comparing, by the information management apparatus, the acquired hardware change information with the transmitted hardware configuration information, and determining whether the hardware change information and the hardware configuration information are consistent; and
updating, by the information management apparatus, the electronic certificate when the hardware change information and the hardware configuration information are consistent.

6. The information management method according to claim 5, wherein
the information management apparatus requests a preset terminal apparatus to approve the change of the hardware in a case where the hardware change information and the hardware configuration information are consistent in the determination, and
the information management apparatus updates the electronic certificate when there is a notification of approval from the terminal apparatus.

7. The information management method according to claim 5, wherein
the electronic certificate includes a first electronic certificate that certifies an initial hardware configuration of the calculator and a second electronic certificate that certifies a portion changed from the initial hardware configuration, and
the information management apparatus issues the second electronic certificate to update the electronic certificate.

8. The information management method according to claim 5, wherein
the hardware monitoring apparatus adds an electronic signature of the calculator to the hardware configuration information,
the hardware monitoring apparatus transmits the hardware configuration information to which the electronic signature is added,
the information management apparatus acquires the hardware change information to which an electronic signature of a person in charge who has performed work of changing the hardware of the calculator is added, and
the information management apparatus performs an authentication process for each of the electronic signature of the calculator added to the hardware configuration information and the electronic signature of the person in charge added to the hardware change information, and when the authentication of each of the electronic signatures is successful, comparing the acquired hardware change information with the transmitted hardware configuration information, and determining whether the hardware change information and the hardware configuration information are consistent.

9. A non-transitory computer-readable recording medium on which a program is recorded,
the program installed in a calculator, the program including instructions for causing the calculator to:
detect a change of hardware of the calculator using an electronic certificate that is issued by an information management apparatus and certifies a hardware configuration of the calculator;
generate hardware configuration information for specifying content of the detected change of the hardware; and
transmit the hardware configuration information to the information management apparatus.
